(19) United States
(12) Patent Application Publication
(10) Pub. No.: US 2013/0341320 A1
(43) Pub. Date: Dec. 26, 2013

(54) INDUCTION HEATING APPARATUS FOR PIPELINE CONNECTIONS

(71) Applicants: Dilip Kumar Tailor, Mississauga (CA); Mark Brandon, Toronto (CA); Martin Sardi, Orangeville (CA); Aaron Klejman, Toronto (CA); Joseph Mordarski, Brampton (CA)

(72) Inventors: Dilip Kumar Tailor, Mississauga (CA); Mark Brandon, Toronto (CA); Martin Sardi, Orangeville (CA); Aaron Klejman, Toronto (CA); Joseph Mordarski, Brampton (CA)

(73) Assignee: ShawCor Ltd., Toronto, ON (CA)

(21) Appl. No.: 13/979,396

(22) PCT Filed: Jan. 13, 2012
(86) PCT No.: PCT/CA2012/050024

§ 371 Date: Sep. 13, 2013

Related U.S. Application Data
(60) Provisional application No. 61/432,852, filed on Jan. 14, 2011.

(51) Int. Cl. F16L 53/00; H05B 6/10

(52) U.S. Cl. CPC F16L 53/004; H05B 6/101
USPC 219/643; 219/674

(57) ABSTRACT

An induction heating apparatus for use in pre-heating pipe joints. The induction heating apparatus comprises a frame for applying around the pipe joint, and an induction heating coil made from Litz cable wires.

### CROSS-REFERENCE TO RELATED APPLICATION

This application claims the benefit of and priority to U.S. Patent Application No. 61/432,852 filed Jan. 14, 2011 under the title INDUCTION HEATING APPARATUS FOR PIPELINE CONNECTIONS.

The content of the above patent application is hereby expressly incorporated by reference into the detailed description hereof.

### FIELD OF THE INVENTION

The present invention relates to an induction heating apparatus for use in heating of pipe joints and sections in pipeline connections. The induction heating apparatus comprises a frame for applying around the pipe joint, and an induction heating coil made from Litz cable wires.

### BACKGROUND OF THE INVENTION

Usually, oil and gas pipe for pipeline construction is an inner, metal pipe, which is coated with a polymer coating. The ends of the pipe are left bare to allow the exposed ends to be welded together at a pipe joint. This pipe joint is then covered and protected. There are several different coating systems used in the art to cover and protect pipe joints and sections. For example, the coating may be in the form of a heat shrinkable sleeve applied around the welded pipe joint. The sleeve is fitted to the pipe joint, then heat shrunk down onto the joint. The sleeve is longitudinally wide enough to overlap the mainline polymer coating of the two sections of pipe. An example of one such sleeve is shown in U.S. Pat. No. 4,521,470, incorporated herein by reference. The coating may be in form of a polymeric tape that is wound onto the joint, with or without heat. The coating may a liquid, such as epoxy or polyurethane, that is brushed on or sprayed on the pipe section.

The application of these coatings in the field requires specific type of steel and mainline coating preparations. The steel is required to be cleaned with wire brushing or grit blasting to remove the rust, and to present a rust free metal surface. Similarly the mainline coating is cleaned and abraded as necessary. The temperature of the substrates need to be above the dew point in order to avoid water condensation on the joint prior to the application of the coating. Therefore prewarming of the pipe section may be necessary. The joint coatings often require certain preheat of the substrate in order to activate the coating to promote the bonding of the coating to the steel and the mainline coating. For example, certain high temperature polypropylene heat shrink sleeves require a preheat of 180° C. of the steel in order to activate the adhesive on the sleeve, while some epoxy liquid coatings need a preheat of 60° C. The heating of the joint or the pipe section is typically done with a propane flame torch, a catalytic gas heater or by induction heating. We have found that the heating of pipe diameters less than 16″ is feasible with a flame torch, but becomes laborious and unreliable on larger diameter pipes. For example, trying to heat a 36″ or a 48″ pipe with flame is very difficult, particularly when the ambient conditions are cold, such as in winter conditions. The heating with flame could take 15-45 minutes on a 48″ pipe in sub-zero climate. Heating the joint for such long period can degrade and damage the mainline coating, and therefore requires extra precautions to protect the mainline coating. The heating with flame tends to be rather random, and uniformity of the temperature all around the pipe circumference is difficult. One particular problem with using flame is that while it is possible to bring the surface temperature of the mainline coating up, the steel underneath the coating is remains relative cold, and is heated only via the heat conducted from the heat applied to the exposed steel at the joint. Therefore the mainline coating loses heat fast due to the “heat-sink” effect under the mainline coating. Therefore it is very difficult to maintain uniformity of the temperature on the steel and the mainline coating that would be overlapped by the joint coating.

Certain problems associated with heating the pipe joint with a flame are eliminated when induction heating is used. The art of induction heating of pipes is well known and described, for example, in patents U.S. Pat. No. 4,388,510, U.S. Pat. No. 115,675, and U.S. Pat. No. 4,595,607, incorporated herein by reference. A typical induction heating coil comprises a core frame upon which suitable cables are wound. The core frame can be made from a non-magnetic material such as phenolic composites or aluminum. The cable design typically includes copper wires. In induction heating, an alternating current from a power source creates an alternating magnetic field, which then induces eddy currents around the powered cables. The eddy currents heat the pipe metal in the vicinity. The magnetic field is controlled to alternate at a certain frequency. The frequency of the magnetic field determines the penetration of the depth of the induction heating into the pipe wall thickness, with the higher the frequency, the lower the penetration depth into the pipe. However, higher frequency concentration on the top surfaces causes faster heating of the surface of the pipe, meaning the temperature will rise more quickly. This is often desirable, as this speeds up the installation time and production rate of the pipeline construction.

The current transmitting through the induction cables also heats up the copper in the cable, as the latter acts as a resistance element. When the frequency is higher, the cable tends to heat up to a greater extent. This is key conundrum faced by the induction heating design engineers. In order to design a fast induction heating system, the engineer would prefer a high frequency magnetic field, but this results in a heating of the induction cable (coil), making it prohibitive due to damage to the cable insulation and connections and also safety of the workers. Therefore the engineer has two choices, as follows.

The first choice is to use a low frequency induction system, so that the copper in the coil heats up very slowly and therefore is able to dissipate the heat. Thus the cable does not get too hot and can be controlled. The downside of this system is that the heating time is much longer, as the low frequency (for example, 440 Hz) has high penetration depth, and the heat is dispersed towards heating the full thickness of the pipe wall.

This first choice is embodied in equipment available from Tesi (Milan, Italy). This induction heating equipment operates at 440 Hz. We used such equipment, including a 120 KWatt Tesi generator, to heat a 660 mm diameter steel pipe with a wall thickness of 30 mm on a joint width of 500 mm. It took 6 minutes to heat the steel from 23° C. to 170° C.

With this equipment, the size of the induction cable was 30 mm in diameter and the coil with the frame weighed 120 kg. The size of the power source and generator was 6 ft long×3.5 ft wide and 4.5 ft high and it weighed 1000 kg.

The second choice is to use high frequency heating so that fast heat up times can be obtained, but to take countermeasures to address overheating of the induction coil. In this type of system, the copper cables of the induction coil must be cooled, and are typically supplied with water-cooling to prevent overheating.

This second choice is embodied in equipment available from Radyne (UK), a division of Inductotherm group. This induction heating equipment, sold under the trade name Radyne Merlin, operates at high frequency. We used such equipment, including a 120 Kwatt generator operating at 20,000 Hz, to heat a 660 mm diameter steel pipe with a wall thickness of 30 mm on a joint width of 500 mm. It took 1 minute to heat the steel from 23° C. to 170° C.

With this equipment, the size of the induction cable was about 25 mm in diameter, but it was water cooled and the coil with the frame weighed in excess of 170 kg. The equipment required a water chiller and provisions cooling the coil cables, making it a complicated design, especially for operations in the field.

As would be evident to a person of skill in the art, transportation of such heavy equipment to such remote fields typical of pipeline installations is also a factor, contributing to the expense and logistics requirements of a pipeline construction.

It would therefore be advantageous to have a light weight high frequency induction coil apparatus that also does not require water cooling for use in heating of pipe joints and sections in the field. It would be advantageous if such an induction coil required less electrical energy, for example, a smaller, more portable electrical power source, such as a diesel electric generator commonly already utilized and present at pipeline installation sites. Finally, it would be advantageous if such an induction coil apparatus could provide the requisite energy without significant inefficiencies in the form of heat discharge, and thus not require water cooling.

### BRIEF DESCRIPTION OF FIGURES

FIG. 1 shows, in somewhat schematic form, an induction coil apparatus according to one aspect of the present invention.

FIG. 2 shows a close-up of a certain aspect of FIG. 1.

FIG. 3 shows, in somewhat schematic form, a second embodiment of an induction coil apparatus of the present invention, positioned around a pipe section.

FIG. 4 shows, in somewhat schematic form, a further embodiment of an induction coil apparatus of the present invention.

FIG. 5 shows, in somewhat schematic form, a further embodiment of an induction coil apparatus of the present invention, positioned around a pipe section.

FIGS. 6-8 show, in somewhat schematic form, a further embodiment of an induction coil apparatus of the present invention, in blanket form. FIG. 6 shows the apparatus; FIG. 7 shows the same apparatus, rolled up for storage or transport; FIG. 8 shows the apparatus positioned around a pipe section.

FIG. 9 shows a radial cross-section of the apparatus of FIG. 8.

FIG. 10 shows a longitudinal cross-section of the apparatus of FIG. 8.

FIGS. 11-12 show, in somewhat schematic form, a further embodiment of an induction coil apparatus of the present invention, in blanket form. FIG. 11 shows the apparatus; FIG. 12 shows a longitudinal cross section of the apparatus positioned around a pipe joint.

FIGS. 13-14 show, in somewhat schematic form, a further embodiment of an induction coil apparatus of the present invention, in blanket form. FIG. 13 shows the apparatus; FIG. 14 shows a longitudinal cross section of the apparatus positioned around a pipe joint.

### DETAILED DESCRIPTION

Litz wire is a type of wire cable typically used in electronics to carry high frequency alternating current. The wire comprises multiple (often hundreds, or thousands) of strands of individually insulated wire. The strands are insulated electrically from each other. The bundle of strands is then typically cased in a further insulated sheath. Strands may be twisted or woven together to provide strength or flexibility, or to equalize the proportion of the overall length over which each strand is at the outside of the conductor, in a variety of configurations and patterns, sometimes involving several levels of weave or twist. For example, a Round Type 1 Litz construction comprises a single twisting operation, in which a plurality of insulated wires are twisted together. Round Type 2 Litz construction comprises a plurality of Type 1 Litz wires, which, in turn, are twisted together. Round Type 3 Litz construction takes bundles of Round Type 2 Litz wires, and twists them together. Each of these constructions also typically comprise an outer insulation, usually of textile yarn, tape, or extruded compounds. A Round type 4 construction features bundles of Round Type 2 Litz wire twisted around a central fiber core. The individual bundles of Litz wire can also be insulated. For example, Round Type 5 Litz construction comprises a plurality of individually insulated bundles of Type 2 Litz wire, twisted around a central fiber core. Round Type 6 construction comprises a plurality of insulated bundles of Type 4 Litz wire, in turn twisted around a fiber core and typically further insulated with an outer insulation. Many other forms of Litz cable are known in the art, including rectangular wire, braided, twisted, compressed, and compacted forms.

Litz wire reduces skin effect and proximity effect losses in conductors used at audio and radio frequencies. Litz wire is used primarily to make inductors and transformers, most regularly for high frequency applications.

The present invention provides an apparatus for use in heating of a pipe joint. The present inventors have surprisingly found that induction coil apparatus for heating a pipe joint can be made comprising a Litz wire instead of a conventional induction copper wire. This provides surprisingly fast heat up times and at much lower power supply, and most importantly without the need for water cooling. The result is that a much thinner wire can be utilized, resulting in a smaller apparatus than the conventional apparatus utilized for this application. The use of Litz wire in the induction coil apparatus allows use of a much higher frequency energy, for example, 20 kHz, which results in the need for a smaller power supply such as a diesel generator, and a much faster, more efficient heating of the pipe. In pipeline applications, the speed at which an operation, such as the heating of a pipe joint, can be undertaken, is directly related to the cost of laying the pipe; accordingly, heating of the pipe at a faster rate results in significant cost savings. A further advantage of the present invention is that the apparatus herein described does not require water cooling, and is cooled with the ambient air. The individual wire strand insulation prevents conduction of heat to the adjacent wires, thus preventing the heating up of the cable and coil. Further, the apparatus does not heat up as much, which prevents possible damage to the cables and connectors and creates less chance of user injury, as compared to prior apparatus.

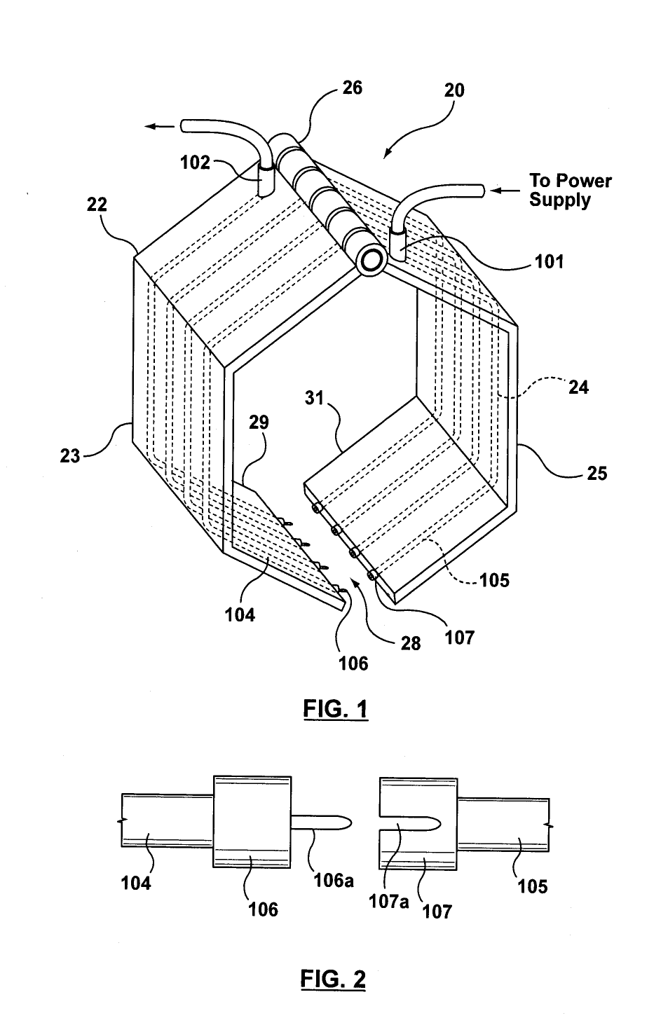

The apparatus may be any shape or configuration such that it surrounds the pipe joint at the location in which fusion is desired. For example and as shown in FIG. 1, the apparatus 20 may comprise a frame 22 onto which or within which a Litz wire cable 24 is coiled to induce magnetic field. The apparatus is of a size and shape such that it is capable of surrounding a pipe. As shown, the frame 22 comprises two wings 23, 25 rotatable around a hinge region 26. The apparatus 20 thus has two configurations; an open configuration where open end 28 can be fit around a pipe, and a closed configuration where open end 28 is closed, with sides 29 and 31 abutting one another. The apparatus 20 has Litz cable starting at a connector terminal 101, coiled around the frame and ending at a connector terminal 102. The leads from the connector terminals 101 and 102 are run to a power source (not shown).

Cable 24 is preferably continuously wound on the frame 22 so that in the operating position it surrounds the pipe section without gap. In order to maintain the current continuity in the two part clam shell design shown in this FIG. 1, quick connectors 106 and 107 are incorporated at the terminals 104, 105, respectively, of cable 24, ending at the bottom of the sides 23 and 25.

FIG. 2 shows a close-up exemplification of these terminals 104, 105, where, in the design shown, a quick connection of quick connectors 106 and 107 is made with a tongue and groove design. It can be appreciated, of course, that any known quick connection system could be utilized.

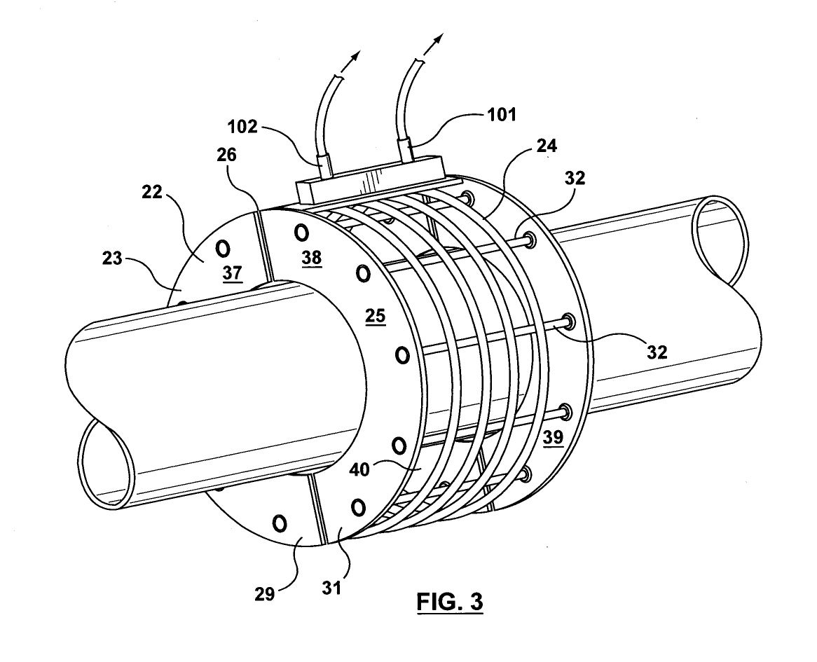

FIG. 3 shows a second embodiment of the apparatus. A circumferentially wound cable 24 on an induction coil frame 22 that is mounted on a pipe section 21. In this figure the frame 22 comprises four semi-circular flanges 37, 38, 39 and 40, connected with hinge region 26 and a series of rods 32 travelling longitudinally in the direction of the pipe length. The rods 32 can be, for example, aluminum or glass reinforced epoxy composite rods. Rods 32 can also be made from aluminium or composite material, such phenolic/glass, that is not susceptible to inductance heating. In certain embodiments (not shown), the apparatus has panels instead of or in addition to rods 32, serving the same purpose. In this design, cable 24 is wound circumferentially onto rods 32. Since the cable 24 is wound circumferentially, terminal connectors (not shown, but similar to those shown in the embodiment shown in FIGS. 1 and 2) at the bottom of the two shell halves 29, 31 are necessary to facilitate the continuous current flow though the coiled cable 24.

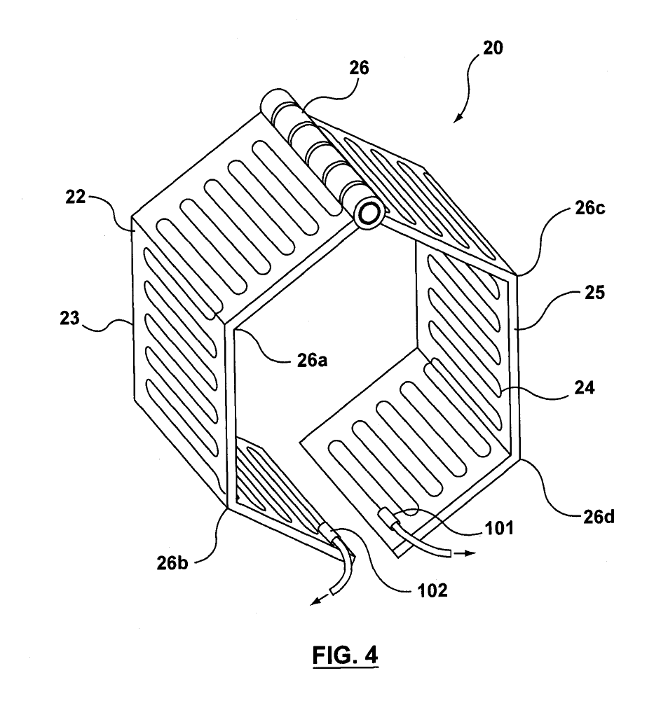

FIG. 4 shows an alternative configuration of the apparatus of the present invention. Here, apparatus 20 has a similar frame 22 comprising clam shell wings 23, 25 and hinge region 26. However, in this configuration, Litz induction cables 24 are configured to traverse transversely across the width of the circular frame 22, with the cable 24 ends (and hence connector terminals, 101, 102) terminating at the extreme ends of the clam shell wings. This design eliminates the need for terminal connectors to maintain current continuity at the bottom halves of the clam shells. Since the cable 24 has small diameter, is light weight and flexible, it can be easily flexed and can be mounted on the frame 22 in any required configuration. Since the cable 24 is light weight and requires no water cooling even at high frequencies, the frame 22 and the entire apparatus 20 becomes light weight. This makes it easy to handle and transport.

Optionally, in one variation of the design shown in FIG. 4, in addition to hinge region 26, the apparatus 20 comprises further hinges, for example, at 26a, 26b, 26c, and 26d as shown in FIG. 4. These additional hinges make the apparatus easier to store and transport. One major practical benefit of this multi-hinged design is that the apparatus becomes easy to maneuver and can be used in confined spaces such on pipe-laying vessel off-shore. A traditional coil with one hinge will have to open up like two butterfly wings; though useful in certain applications, the wide span, especially on large diameter pipes like 36″ or 48″ pipes, is sometimes less than ideal, and may pose a safety hazard for the workers. In certain embodiments, the multi-hinged design does not need to open as greatly as a design with two full span wings, but rather can flex at the hinges to open only sufficiently to clear the pipe to be heated.

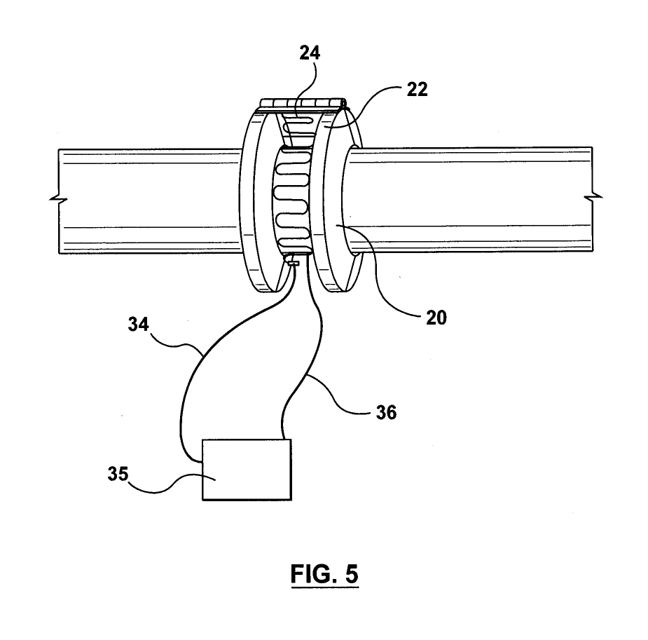

FIG. 5 shows an embodiment of the induction coil apparatus of the present invention as shown on FIG. 4, in situ, surrounding a length of pipe 21. Apparatus 20 surrounds pipe length 21 and comprises frame 22 and is connected by electrical lead 34 and 36 to electrical power source 35. As shown, the apparatus 20 is hinged, and is positioned on to the pipe 21 by opening, placing on the pipe, then closing the clam shell. After each operation, the apparatus 20 is opened, and transported along the pipe 21 from one pipe weld to the next, where it is closed into position.

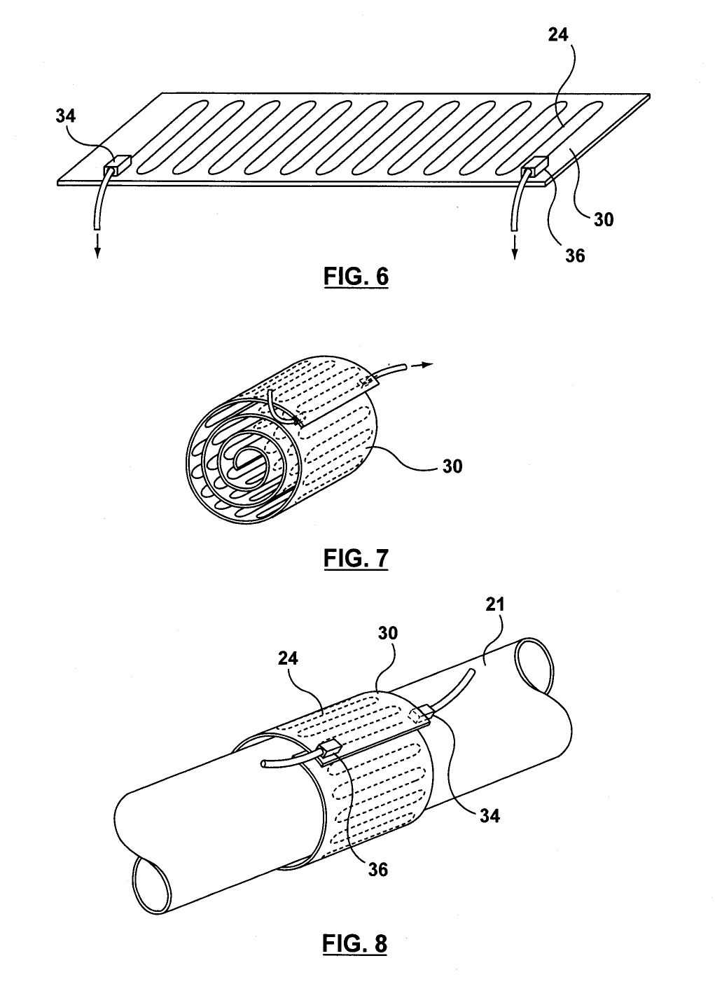

A further embodiment of the invention is shown in FIGS. 6-8. Here, the apparatus is in the form of a flexible blanket 30 which can be wrapped around a pipe 21. This was a major discovery in being able to design and practically fabricate a true flexible induction blanket. This was almost impossible to do with the traditional induction cables and especially difficult when running at high frequencies that required water cooling. The use of the thin, light weight, and flexible Litz cable suddenly allowed the possibility of making a flexible blanket.

This eliminated the problems and constraints of with the traditional cables and allowed the following benefits:
1. Make flexible induction blanket that is light weight and easy to handle and carry in the field from one joint to another. The traditional coil requires a use of motorized crane to move the coil, while the flexible blanket can be even be hand carried or placed on a hand wheeled trolley.
2. Since the blanket can be rolled up, the means of transportation and storage are much simplified and made less costly.
3. The flexibility of blanket allows the designing the blanket to fit regular pipe sections as well as odd shapes such as pipe bends and flanges.
4. The flexible blankets are easy to design and manufacture, which reduces delivery times and also makes the apparatus less costly to produce.

The blanket 30 may be made of any material, but is preferably a flexible, heat resistant material such as a polymeric material, a woven fabric, or a composite of fiber or fabric with polymeric matrix, for example, elastomers such as silicone and neoprene, or a fabric made from polyester, nylon, polyolefin, Kevlar™ fiberglass or cotton fibers, or a composite of these fabrics or fibers with a polymeric matrix. The blanket 30 has attached to, or incorporated within its structure, Litz wire cable 24 which is coiled to introduce inductance, and connected by electrical leads 34, 36 to a power source 35. In the embodiment shown in FIGS. 6-8, the cable 34 is configured to traverse transversely across the width of the blanket 30, with the cable ends (and hence leads 34, 36) terminating at the extreme ends of the blanket 30. This eliminates the need for terminal connectors to maintain current continuity.

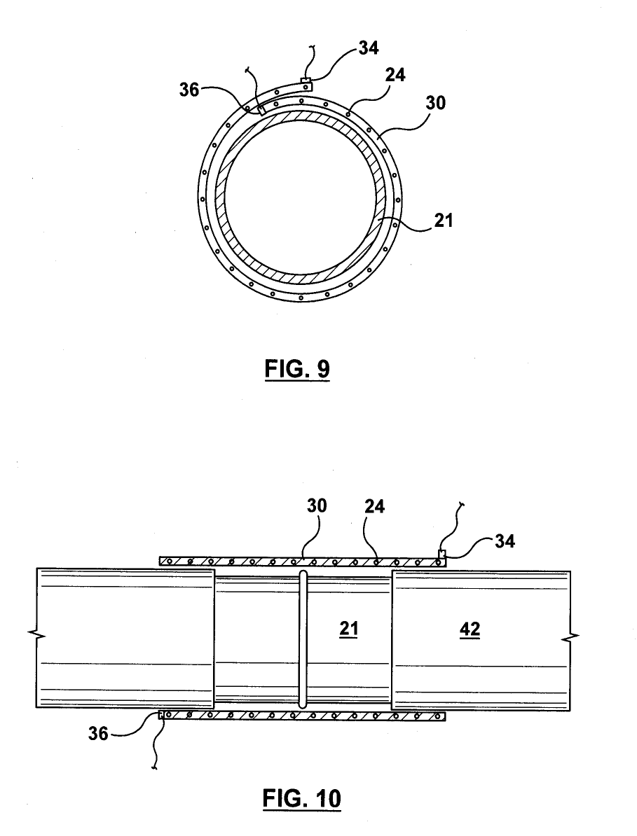

FIG. 9 shows a radial cross-section of the blanket 30 of FIG. 6-8, applied to a pipe 21. Here, we can see that the blanket 30 has very close contact with the pipe 21. FIG. 10 shows a longitudinal cross-section of the same blanket 30 applied to a pipe 21 at a joint; again, the blanket 30 can be seen to have intimate contact with the pipe 21, and more particularly, the mainline coating 42. In this case, the blanket may touch both the steel of the pipe 21, and the mainline coating 42.

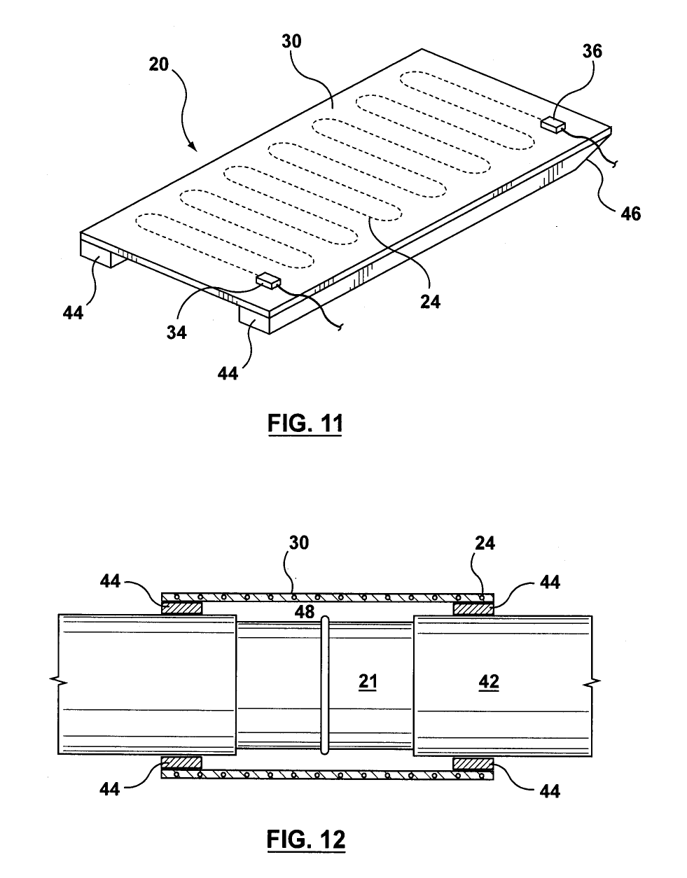

FIGS. 11 and 12 show a further embodiment of the invention. Here, like in FIGS. 9 and 10, the apparatus is in the form of blanket 30, with wire 24 which is coiled to introduce inductance, and connected by electrical leads 34, 36 to a power source (not shown). However, in this particular embodiment, the apparatus 20 also has spacers 44 running along two opposing edges of blanket 30. Spacers 44 are preferably made from a non-conducting, flexible, heat resistant material, such as rubber. The spacers 44 comprise bevel 46 on one end, to form an overlap so that blanket 30 can be flush at the overlapping region. Spacer 34 allow for separation 48 when the blanket 30 is applied to a pipe 21. Such separation 48 is especially desirable when pipe 21 is coated with a liquid primer or other wet coating substance before heat is applied.

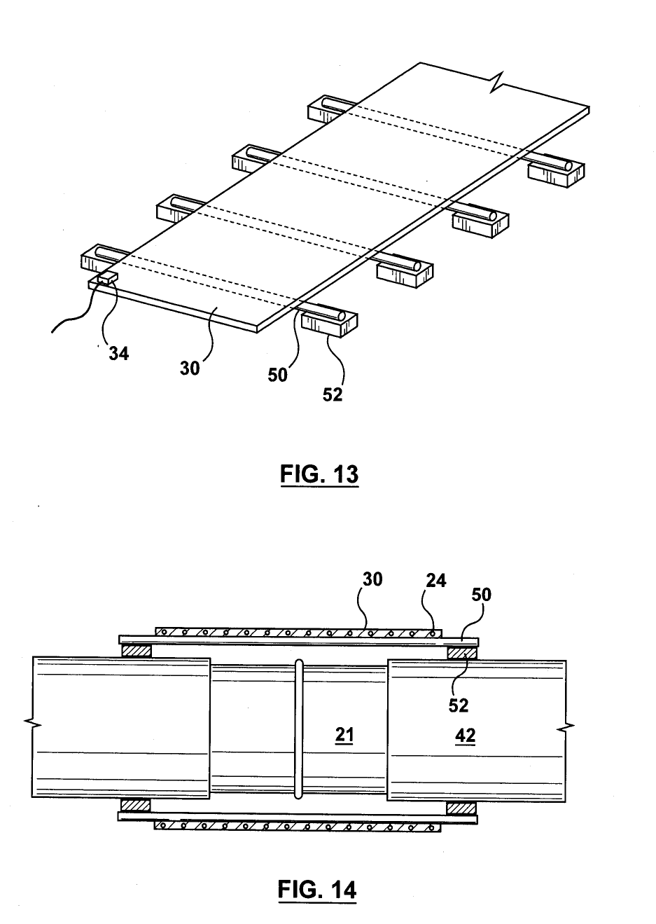

FIGS. 13 and 14 show yet another embodiment of the invention in the form of a blanket 30, having wire 24 coiled to introduce induction, connected by electrical leads 34, 36, to a power apparatus, that, like the embodiment in

FIGS. 11 and 12, allows for separation 48 between the blanket 30 and the pipe 21. Here, the apparatus 20 comprises rods 50 traversing across the blanket, and running parallel to one another. At each end of each rod 50 is a spacer 52. The rods 50 are preferably made of a rigid, non-conducting material, such as nylon. Spacer 52 is also preferably made of a rigid, non-conducting material, such as nylon. FIG. 14 shows the apparatus as applied to a pipe 21.

### EXAMPLES

### Example 1

To contrast with the 125 Kwatt Tesi induction heating equipment operating at 400 Hz, an experiment was done using a two 30 kw Kwatts Miller units hooked up in series to obtain 60 Kwatts. This generated a frequency of 20,000 Hz. (Miller Electric Mfg. Co., Appleton, Wis. This was powered with a 75 kw diesel generator.

An induction apparatus with a design configuration according to FIG. 1 was manufactured, and connected to these Miller units.

The apparatus was used to heat 660 mm diameter pipe with a wall thickness of 30 mm on a joint width of 500 mm. The apparatus took 1.5 minutes to heat the steel from 23° C. to 170° C. In comparison with the traditional induction heating apparatus, this was a quarter of the time than it took with the Tesi 400 hz unit, utilizing half the power.

In addition, the apparatus had a wire cable of 7 mm in diameter and the entire apparatus, including wire coil and frame, weighed 35 kg. The combined weight of the diesel generator and the two Miller units was 378 kg.

### Example 2

A pipeline project required a Canusa heat shrink sleeve coating to be applied to the pipe joint on a 84″ diameter pipe. The pipe wall thickness was 50 mm and mainline coating was polyethylene. The exposed steel of the pipe ends was welded together, so that a joint with 300 mm exposed steel was present and the adjacent areas were coated with 5 mm thick polyethylene. The coating to be used was a Canusa GTS-80 sleeve (Shawcor Ltd., Rexdale, Canada) which required a preheat of the joint to 110° C. prior to application of the sleeve.

First an experiment was done to heat the pipe with 2 torches, each with 200,000 BTU capacity and by two people. It took 22 minutes to heat the joint steel from 23° C. to 110° C. It was determined that it would be difficult to heat such a big pipe by 2 or even 4 people with a torch flame and obtain uniform temperature and in reasonable amount of time. Thus heating of the joint with an induction coil was obviously desirable. However, traditional clam shell coil induction apparatus were not practical due to the diameter of the pipe—the engineering involved in design and fabricating the apparatus, and the difficulty of handling such a coil frame in the field made it evident that this was not at a practical proposal.

A flexible blanket as described in FIG. 6 was therefore prepared. The fabric used was polyvinylchloride/glass cloth laminate, 1.5 mm thick, and had a flexibility of a rubber sheet with Shore hardness of Shore A40. A 7 mm diameter Litz cable was attached to the laminate fabric using nylon ties in the configuration shown in FIG. 6. The width of the induction blanket was 550 mm so that it could also heat the steel under the mainline coating adjacent to the exposed steel cutback. A 26 meter length of Litz wire cable was coiled and attached to the blanket. The blanket weighed 72 kg, which 2 people could carry and handle. It was calculated that a traditional Tesi-type induction coil for the same size and effect would weigh approximately 500 kg.

The induction blanket was wrapped around the joint in a manner shown in FIG. 7, whereby the blanket is wrapped relatively tautly on to the joint, so that the blanket may touch the areas of the steel on the exposed cutback. The power was supplied by using two 30 kw Kwatts Miller units hooked up in series to obtain 60 Kwatts. It generated a frequency of 20,000 Hz. This was powered with a 75 kw diesel generator. It took 10 minutes to heat the joint steel from 23° C. to 110° C. This was done in less than half the time compared to the heating done by a torch with employing the same number of people. It would be understood to a person of skill in the art that on this size pipe it would be possible, and likely desirable, to use higher wattage, for example 120 Kwatts or even more, which would likely make it possible to reduce the heat-up time to less than 2-3 minutes.

### Example 3

This experiment was conducted for the application of Canusa HBE liquid epoxy coating onto a pipe joint with a fusion bonded epoxy mainline coating. The installation procedure required the prewarming of the joint to 50° C. to remove the moisture, then application of the liquid epoxy with a roller, and then heating the joint to 95° C. In this application, since there is a wet liquid on the joint, the clam-shell induction coil as shown in FIG. 3 would be quite suitable, since the cables would remain elevated away from the joint surface, and the wet liquid is not disturbed. However, on large diameter pipes, such as 56″ or 84″ pipes, the use of the large clamshell coil would be considered undesirable, especially in rough terrains in the field. An induction blanket solution would be preferable.

To this end, a joint was prepared in the lab on a 48″ fusion bonded epoxy coated pipe with an exposed steel cutback of 300 mm. The joint was heated to 50° C. with the induction blanket of FIG. 7 using two 30 kw Kwatts Miller units hooked up in series to obtain 60 Kwatts. It generated a frequency of 20,000 Hz. This was powered with a 75 kw diesel generator. It took 55 seconds to heat the joint steel from 23° C. to 50° C.

Then the epoxy liquid was rolled on the steel surface at a thickness of 1.0 mm. It was evident that, after the epoxy liquid was applied to the steel surface, the induction blanket of FIG. 7 would not suffice—if the blanket was simply wrapped around the joint, it would touch the wet liquid and disturb the coating. Therefore it was necessary to make a blanket which was elevated from the joint surface, so that the liquid was not touched.

A blanket as shown in FIG. 11 was therefore manufactured. Here, the sides of the blanket have a rubber strip attached running all the way along the edge on the underside. The strip was beveled on one end that forms the overlap in order to keep it flush at the overlapping region. For this experiment, the strip was made from Neoprene rubber with a Shore A Hardness of 40, with a thickness of 25 mm and a width of 60 mm, on blanket of 500 mm width. When the blanket was wrapped around the joint, there was a slight sag between the rubber spacers. A separation of 10-25 mm was formed between the blanket and the steel surface, and no contact was made with the liquid epoxy. The heating was done in 2.5 minutes from 42° C. to 95° C.

A blanket as shown in FIG. 13 was also manufactured, to prevent the slight sagging observed in the blanket of FIG. 11. As shown in FIG. 13, the rods were made of 7 mm diameter nylon, and were mounted onto spacers also made from nylon blocks 35 mm×25 mm and 20 mm height. The rods were spaced every 300 mm around the circumference to keep the blanket elevated. The heating of the joint was carried out in 2 min 40 seconds from 40° C. to 95° C.

### Parts List

20—induction coil apparatus

21—pipe

22—frame

23—wing

24—Litz cable

25—wing

26—hinge region

26a, b, c, d—hinge regions

27—pipe joint

28—open end

29—side

30—blanket

31—side

32—rods

34—electrical lead

36—electrical lead

37—flange

38—flange

39—flange

40—flange

42—mainline coating

44—spacer

46—beveled edge

48—separation

101—connector terminal

102—connector terminal

104—terminal

105—terminal

106—quick connector

107—quick connector

1. An apparatus for applying induction energy to a pipe or pipe section, comprising:
a frame or blanket capable of enveloping said pipe;
an induction coil mounted on or in said frame or blanket;
an electrical supply connection for connecting said induction coil to an electrical supply
wherein the induction coil is made from a Litz cable.

2. The apparatus of claim 1 wherein the frame is a rigid frame having a first configuration wherein the frame is capable of enveloping said pipe and a second configuration wherein the frame is capable of being removed from said pipe.

3. The apparatus of claim 2 wherein the frame further comprises a hinge region and is capable of being moved from said first configuration to said second configuration by means of rotation around said hinge region.

4. The apparatus of claim 3 wherein the frame further comprises a plurality of hinge regions.

5. The apparatus of claim 1 wherein the induction coil is circumferentially wound around the frame.

6. The apparatus of claim 5 wherein the induction coil maintains current continuity when in the first configuration and does not maintain current continuity when in the second configuration.

7. The apparatus of claim 6 wherein the induction coil comprises a plurality of quick connectors which each connect a portion of the induction coil to a second portion of the induction coil when the apparatus is in the first configuration, and which disconnect the portion of the induction coil from the second portion of the induction coil when the apparatus is in the second configuration.

8. The apparatus of claim 1 wherein the induction coil is configured to traverse transversely across the width of the frame.

9. The apparatus of claim 8 wherein the induction coil maintains current continuity in both the first and the second configurations.

10. The apparatus of any one of claims 1-9 further comprising connector terminals configured to receive a cable connected to a power source.

11. The apparatus of claim 1 wherein the frame or blanket is a flexible frame.

12. The apparatus of claim 10 wherein the frame or blanket is a blanket.

13. The apparatus of claim 12 wherein the blanket is primarily of a material selected from a polymeric material, a woven fabric, or a composite of fiber or fabric with polymeric matrix.

14. The apparatus of claim 13 wherein the blanket is primarily of a material selected from elastomers such as silicone and neoprene, or a fabric made from polyester, nylon, polyolefin, Kevlar, fiberglass or cotton fibers, or a composite of these fabrics or fibers with a polymeric matrix.

15. The apparatus of claim 12, further comprising a set of spacers running along two opposing edges of the blanket.

16. The apparatus of claim 15 wherein the spacers are a non-conducting, flexible, heat resistant material.

17. The apparatus of claim 16 wherein the spacers are rubber.

18. The apparatus of claim 15 wherein the spacers are beveled at one end.

19. The apparatus of claim 15 wherein the spacers are beveled at both ends.

20. The apparatus of claim 12 further comprising a plurality of rods traversing generally parallel to one another across the blanket, and spacers at each end of said rods.

21. A method for heating a steel pipe section, comprising applying inductive energy to said pipe section, wherein the inductive energy is applied by an inductive coil made from Litz cable and circumferentially disposed around said pipe section.

22. The method of claim 21 wherein the inductive energy is applied utilizing an apparatus of any one of claims 1-20, disposed around said pipe.
